(19) United States
(12) Patent Application Publication
(10) Pub. No.: US 2026/0188928 A1
(43) Pub. Date: Jul. 2, 2026

(54) HYBRID CONNECTOR FOR A LARGE MODULAR SYSTEM

(71) Applicant: Arista Networks, Inc., Santa Clara, CA (US)

(72) Inventors: Jason Chan, San Jose, CA (US); Daehwan Daniel Kim, Sunnyvale, CA (US); Man Him Andrew Ho, Santa Clara, CA (US); Youngbae Park, Milpitas, CA (US); James Alden Weaver, Palo Alto, CA (US)

(21) Appl. No.: 19/005,586

(22) Filed: Dec. 30, 2024

(51) Int. Cl. H01R 12/71; H01R 13/516; H01R 43/18; H01R 43/26

(52) U.S. Cl. CPC H01R 12/716; H01R 13/516; H01R 43/18; H01R 43/26

(57) ABSTRACT

A hybrid connector for computing devices, such as large modular network devices, is provided. The hybrid connector comprises a board mount connector that has a board mount side mountable to a printed circuit board (PCB). The board mount connector has a mating interface for mating with a non-board mount connector, such as a cable connector. The mating interface includes contacts electrically connected to the board mount contacts. The hybrid connector further includes a cable connector mounted to the board mount connector away from the board mount side. The cable connector terminates a plurality of cables and has a second mating interface comprising contacts connected to the cables.

### TECHNICAL FIELD

This disclosure relates generally to computer system architecture. More particularly, embodiments relate to connectors for connecting components in a computer system.

### BACKGROUND

Network devices, such as switches, routers, gateways, and other types of network devices, may include network processors to handle forwarding decisions for forwarding traffic (e.g., to handle Layer 2 switching or Layer 3 switching/routing). In high-capacity network devices, the network processors may be implemented as application specific integrated circuits (ASICs). An ASIC can be orders of magnitude faster than a programmed central processing unit (CPU) for forwarding packets.

As the bandwidth of network processors increases, prior solutions for interconnecting components of modular network devices may no longer be sufficient. For example, long traces from network ASICs to backplane connectors can lead to unacceptable insertion losses, particularly at high data rates.

### BRIEF DESCRIPTION OF DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features.

FIG. 1 is a diagrammatic representation of one embodiment of a modular network device.

FIG. 2 is a diagrammatic representation of one embodiment of a line card.

FIG. 3A is a diagrammatic representation of a front oblique view of one embodiment of a hybrid connector.

FIG. 3B is a diagrammatic representation of a rear oblique view of one embodiment of a hybrid connector.

FIG. 3C is a diagrammatic representation of a partially exploded view of one embodiment of a hybrid connector.

FIG. 4 is a diagrammatic representation of a rear oblique view of a line card.

FIG. 5 is a diagrammatic representation of a side-by-side arrangement of one embodiment of a hybrid connector.

FIG. 6 is a diagrammatic representation of one embodiment of a hybrid connector having a stacked arrangement.

FIG. 7 is a diagrammatic representation of one embodiment of a hybrid connector having a side-by-side arrangement.

### WRITTEN DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

Embodiments of the present disclosure provide a hybrid connector that comprises a stacked board mount connector and cable connector in an assembly. The board mount connector comprises a board mount side that is mountable to a printed circuit board (PCB). The board mount connector has a mating interface for mating with a non-board mount connector, such as a mating cable connector. The mating interface includes contacts that are connected to the board mount contacts of the board mount connector. The cable connector is mounted to the board mount connector away from the board mount side (and away from the PCB when assembled on a PCB). The cable connector terminates in a plurality of cables and has a mating interface comprising contacts connected to the cables.

According to one embodiment, the hybrid connector includes a pair of sidewalls, which may be mountable to the PCB. When assembled, the board mount connector and the cable connector are disposed between the sidewalls.

The hybrid connector may include features to help guide and align components during assembly and to prevent relative movement of components. According to one embodiment, at least one of the sidewalls comprises an inward projection. The board mount connector defines a slot into which the inward projection projects and wherein the cable connector defines a slot into which the inward projection projects. The inward projection may be used to guide movement of the board mount connector and cable connector during assembly or to prevent the board mount connector or cable connector from moving in one or more directions. As another example, the board mount connector may include an alignment pin to align the cable connector on the board mount connector where the cable connector comprises an opening that receives the pin.

In some embodiments, the cable connector is non-destructively removable from the hybrid connector.

Another aspect of the present disclosure includes a network device that incorporates one or more hybrid connectors. According to one embodiment, a network device comprises a PCB, a first switching application specific integrated circuit (ASIC) mounted to the PCB; a second switching ASIC mounted to the PCB and a hybrid connector such as discussed above. According to one embodiment the hybrid connector is connected to the first switching ASIC by board traces in the PCB and to the second switching ASIC via the plurality of cables. In an even more particular embodiment, the first switching ASIC is closer to the hybrid connector than the second switching ASIC is to the hybrid connector. In some embodiments, the ASICs are connected to a plurality of hybrid connectors where, for example, the hybrid connectors function as backplane connectors.

Another aspect of the present disclosure includes a method for an input/output connector. The method, according to one embodiment, includes assembling a hybrid connector. Assembling the hybrid connector may include mounting a board mount connector to a printed circuit board (PCB), where the board mount connector includes a mating interface for mating with a non-board mount connector. The method may further include mounting a cable connector to the board mount connector away from the PCB. The cable connector, according to one embodiment, terminates a plurality of cables and includes a mating interface for connecting to a mating connector. The method may also include connecting the hybrid connector to a first network processor via the plurality of cables.

Embodiments of the present disclosure provide a number of advantages. In some embodiments, the signal trace from the board mount connector portion of the hybrid connector travels a relatively short distance to the ASIC (or other processor) which is near to the connector such that no retimer is required. Further, the cable connector portion of the hybrid connector may be connected by low insertion loss cables to an ASIC (or component) that is farther away such that, again, no retimer is needed. A hybrid connector can thus reduce the need for retimers between the ASICs and backplane connectors while requiring fewer cables compared to implementing the same number of data lanes using an all-cabled connector. As such, a hybrid connector-based approach can support high data rates without the use of retimers in the ASIC-to-backplane signal paths while also avoiding bulky cabling harnesses that require excessive volume and severely impact air flow and cooling.

Further, some embodiments described herein provide another advantage by reducing board space compared to a side-by-side arrangement of connectors. A larger board results in longer trace lengths and increased insertion loss. The stacked arrangement of some embodiments of hybrid connectors helps maintain a smaller board size and hence lower insertion losses in traces.

Further, some embodiments provide an advantage by allowing the hybrid connector to be non-destructively disassembled. Thus, for example, if the cable connector is to be replaced (e.g., due to damage or for any other reason), it may be non-destructively removed (e.g., without damaging the board mount connector, requiring breaking of adhesive or other bonding agent between cable connector and board mount connector, etc.) and replaced without having to remove and replace the board mount connector. Similarly, if the board mount connector is damaged or otherwise requires replacement, it may be replaced without requiring a replacement cable connector.

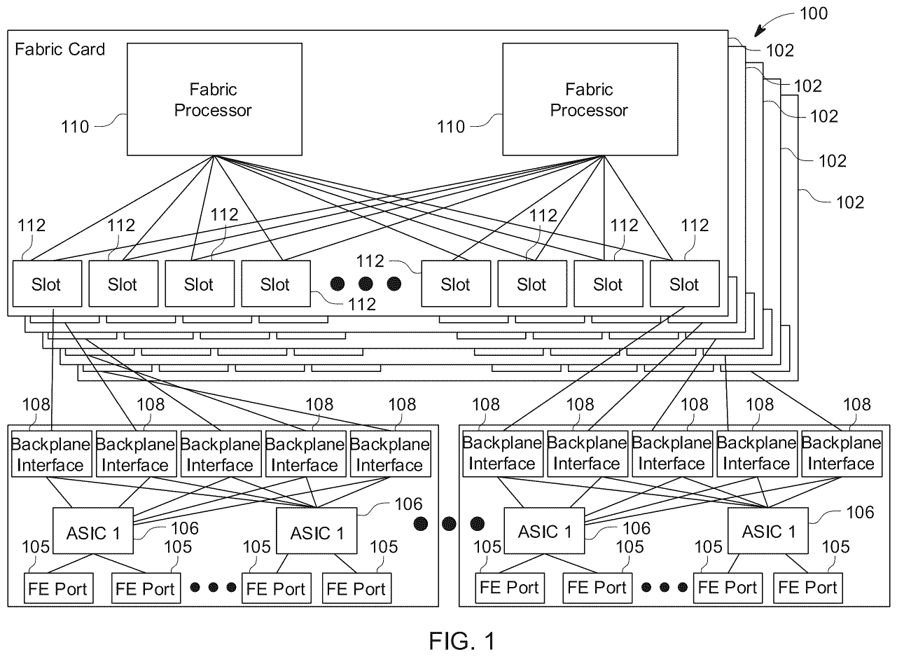

FIG. 1 is a diagrammatic representation of a data plane of a large modular network device 100 that comprises a plurality of fabric cards 102 and a plurality of line cards 104. In this example, network device 100 includes five fabric cards 102 and eighteen line cards 104 (two of which are illustrated).

Each line card (LC) 104 provides front-end ports 105 (e.g., ethernet ports or other network ports) for network connections. Each LC 104 also includes backplane connectors 108 for connecting to the signal paths of fabric cards 102 (as used herein “backplane connector” includes backplane connectors). In the illustrated embodiment, each LC 104 includes five backplane connectors 108 and can thus connect to each of the five fabric cards 102. According to one embodiment, one or more backplane connectors 108 of each LC 104 is a hybrid connector that includes a combination of a board mount connector and a cable connector. Each LC 104 also includes a pair of switching ASICs 106 (or other switching network processors), each of which is connected to respective subset of the front-end ports 105 and to each of the backplane connectors 108. The switching ASICs 106 provides packet forwarding and may perform, for example, Layer 2 switching or Layer 3 routing. The switching ASICs 106, for example, forward traffic between ports 105 of the respective LC 104 and traffic to/from the fabric cards 102. The switching ASICs 106 also provide functionality such as quality of service, traffic shaping and policing, protocol handling and other network traffic processing functionality.

Each fabric card (FC) 102 includes a pair of fabric ASICs 110 connected to slots 112. Each slot 112 includes a connector compatible with a respective backplane connector 108. Fabric ASICs 110 provide a fabric for transferring traffic between components of modular network device 100. Fabric ASICs implement internal forwarding of traffic between ingress and egress ports connected to different switching ASICs 106 on the same or on different LCs.

According to one embodiment, network device 100 is a high bandwidth system (e.g., 224 Gbps). Focusing on the LCs, the bandwidth between ASIC 1 and ASIC 2 of an LC 104 is preferably balanced across the fabric card connectors. As the data rates supported by network devices increase, insertion loss in board traces becomes very high. Possible options for addressing this problem include retimers to condition signals to compensate for loss, low insertion loss cables to minimize loss, or a combination thereof. Retimers, however, consume additional power and take up valuable space. Bulky cable harnesses also take up valuable space and can block air flow. Embodiments of the present disclosure address these problems using a hybrid connector that provides an interface to both board traces and cables (e.g., low insertion loss cables). The hybrid connector allows for a reduced harness size compared to using low insertion loss cables for the same number of diff pairs as supported by the hybrid connector. The hybrid connector also reduces or eliminates the need for retimers for longer signal paths.

Network device 100 is one illustrative embodiment of a network device that incorporates one or more hybrid connectors. Hybrid connectors, however, may be used in a variety of network devices including, but not limited to, modular network devices that include a different number of fabric cards 102, fabric processors 110 per fabric card 102, slots 112 per fabric card, line cards 104, front end ports 105, backplane connectors 108, or switching processors (e.g., switching ASICs 106) than illustrated in FIG. 1.

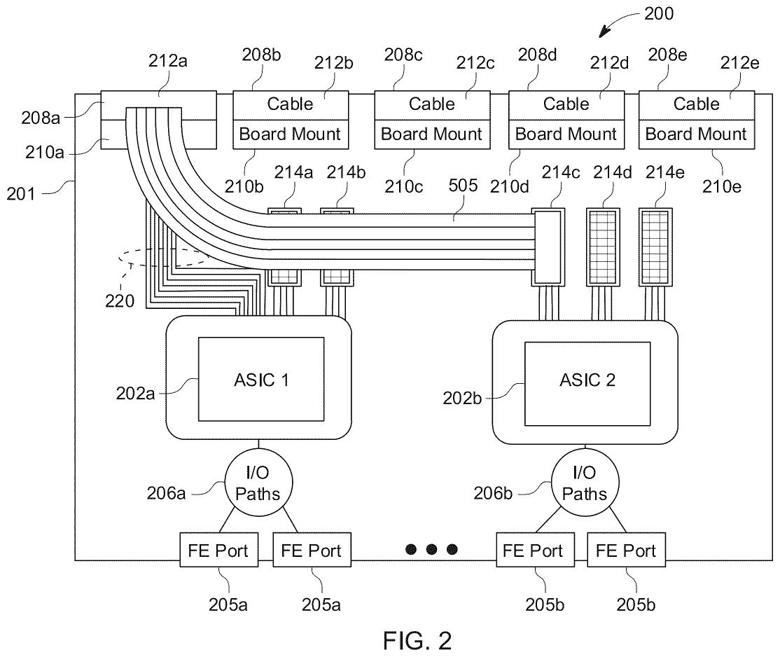

FIG. 2 is a diagrammatic representation of embodiment of a line card 200, which may be used, for example as an LC 104, in one embodiment. LC 200 includes switching ASIC 202a and switching ASIC 202b. LC 200 provides front-end ports (e.g., ethernet ports or other network ports) for network connections. Front end ports 205a connect to switching ASIC 202a via I/O paths 206a and front-end ports 205b connect to switching ASIC 202b by I/O paths 206b.

Each LC 200 also includes backplane connectors for connecting to the signal paths of fabric cards. In the illustrated embodiment, LC 200 includes five backplane connectors (backplane connector 208a, backplane connector 208b, backplane connector 208c, backplane connector 208d and backplane connector 208e) mounted to PCB 201. Each backplane connector of LC 200 is a hybrid backplane connector and includes a board mount connector and a cable connector. Thus, backplane connector 208a includes board mount connector 210a and cable connector 212a, backplane connector 208b includes board mount connector 210b and cable connector 212b, backplane connector 208c includes board mount connector 210c and cable connector 212c, backplane connector 208d includes board mount connector 210d and cable connector 212d, and backplane connector 208e includes board mount connector 210e and cable connector 212e. The hybrid connectors connect to a fabric card and, in even more particular embodiments, cable connectors of the fabric cards. LC 200 further includes cable-to-board connector 214a and cable-to-board connector 214b connected to ASIC 202a, and cable-to-board connector 214c, cable-to-board connector 214d, and cable-to-board connector 214d connected to switching ASIC 202b (e.g., by board traces).

For each backplane connector, half of the signal paths go to the ASIC which is nearer to the connector and the remaining half of the signal go to the ASIC which is far from the connector in the figure. Thus, according to one embodiment, the board mount connector of a hybrid connector connects to the nearest ASIC via board traces and the cable connector portion of the hybrid connector connects to the ASIC that is farther away via a cabled connection, though other schemes for connecting signal paths may be used.

In the embodiment of FIG. 2, switching ASIC 202a has a short enough route to backplane connector 208a to be done by board trace. Thus, ASIC 202a is connected to board mount connector 210a via traces 220 and can thus route traffic to and receive traffic from board mount connector 210a via traces. ASIC 202b, on the other hand, has a relatively long route to backplane connector 208a and is thus connected to cable connector 212a portion of backplane connector 208a via low insertion loss cables 222 that run between cable-to-board connector 214c and cable connector 212a.

The other connections between the ASICs and hybrid connectors are not illustrated in FIG. 2 to avoid obscuring other details. According to one embodiment, ASIC 202a connects via board traces to board mount connector 210b portion of backplane connector 208b and board mount connector 210c portion of backplane connector 208c, connects to backplane connector 208d via cables from cable-to-board connector 214a to cable connector 212d portion of backplane connector 208d, and connects to backplane connector 208e via cables from cable-to-board connector 214b to cable connector 212e portion of backplane connector 208e. Further, in one embodiment, ASIC 202b connects to backplane connector 208b via cables from cable-to-board connector 214d to cable connector 212b portion of backplane connector 208b, connects to backplane connector 208c via cables from cable-to-board connector 214e to cable connector 212c portion of backplane connector 208c, and connects via traces to board mount connector 210d portion of backplane connector 208d and board mount connector 210e portion of backplane connector 208e.

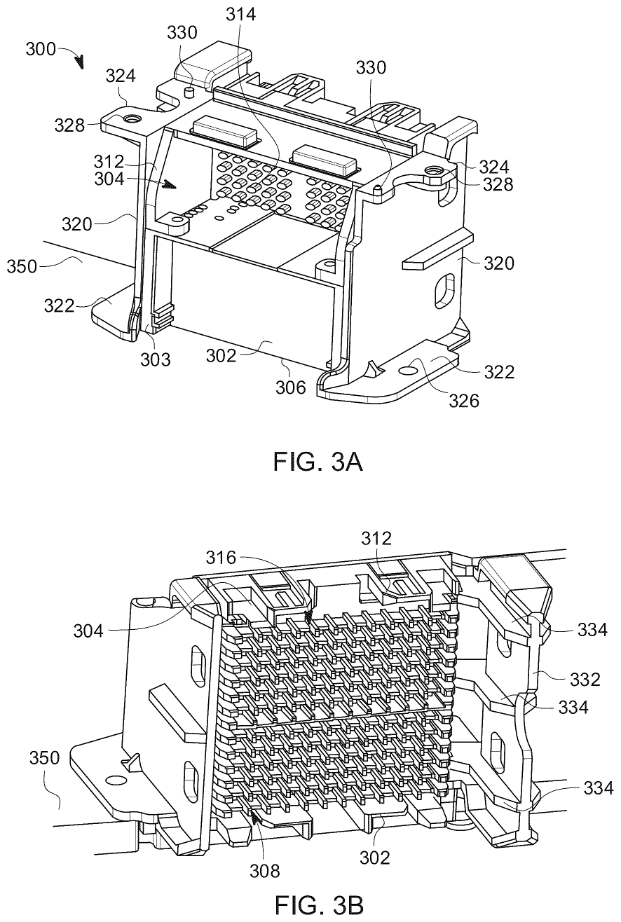

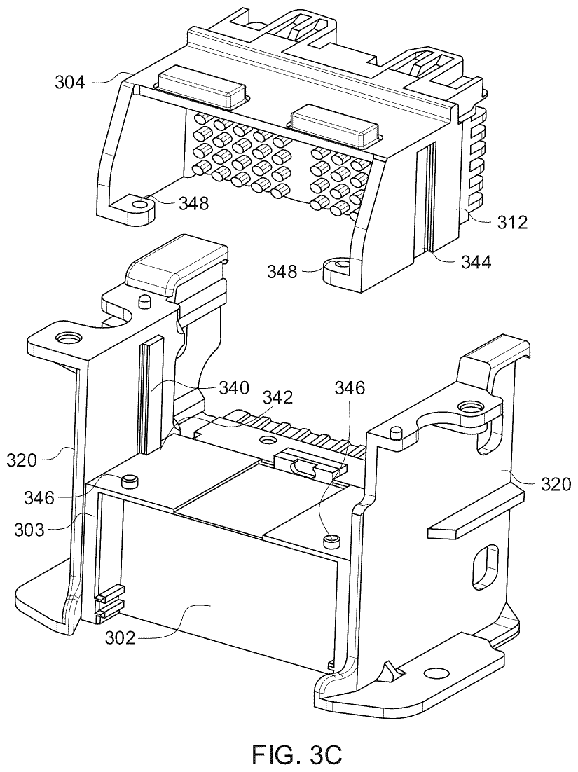

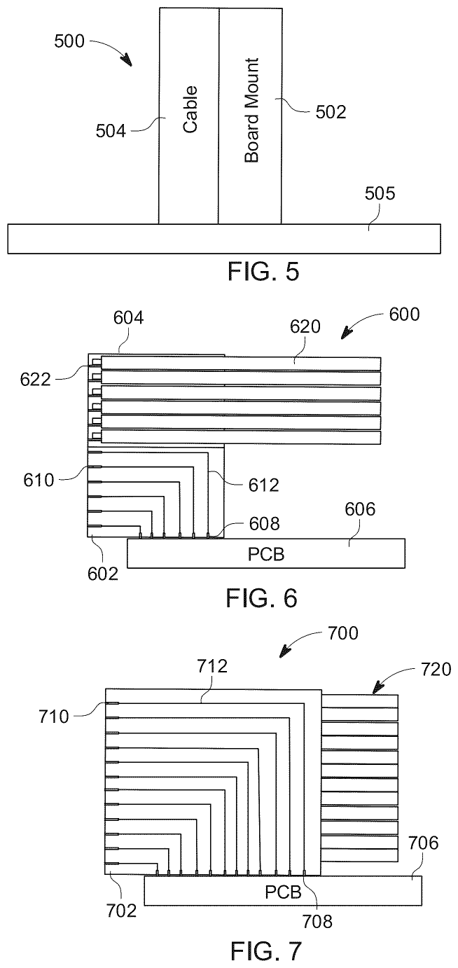

In one embodiment, one or more of the hybrid connectors has a stacked configuration in which the cable connector is to the opposite side of the board mount connector. Using the example of backplane connector 208a, in one example of such an arrangement, board mount connector 210a is mounted to PCB 201 and cable connector 212a is mounted to the side of board mount connector away from PCB 201. One non-limiting example of a stacked configuration is illustrated in FIG. 3. In another embodiment, one or more hybrid connectors has a side-by-side arrangement in which the cable connector is positioned next to the board mount connector along the PCB. Using the example of backplane connector 208a, in one example of such an arrangement, board mount connector 210a is mounted to PCB 201 and cable connector 212a is mounted next to board mount connector along PCB 201. One embodiment of a side-by-side configuration is illustrated in FIG. 5. Regardless, a hybrid connector can act as a single connector such that a mating connector can mate across the board mount connector and cable connector as if they are single connector.

Line card 200 is one illustrative embodiment of a network device that incorporates one or more hybrid connectors. Hybrid connectors, however, may be used in a variety of network devices including, but not limited to, line cards that include a different number of front-end ports, backplane connectors, switching processors, etc. than illustrated in FIG. 2.

FIG. 3A, FIG. 3B and FIG. 3C (collectively FIG. 3) are diagrammatic representations of one embodiment of a hybrid connector 300 that includes a board mount connector 302 and a cable connector 304 stacked thereon. Various techniques can be used for mounting board mount connector 302 to a PCB, such as surface mount technologies, compression contacts, press fit pins, solder tails, or other techniques. According to one embodiment, board mount connector 302 is a lead frame connector. Cable connector 304 is a connector that terminates signal cables and, even more particularly, low insertion loss cables.

Board mount connector 302 includes an insulative board mount connector housing 303 that defines a front end and a back end and supports a plurality of mating interface signal contacts. Board mounted connector 302 includes an array of board mount signal contacts (e.g., pads, pins, balls, solderless compression contacts, solder tails or other board mount features) on its board mount side 306 (the face that faces PCB 350) and can be mounted to a PCB (e.g., PCB 350). Board traces provide signal paths from other components of a computing system to board mount connector 302. In one embodiment, the board traces connect between board mount connector 302 and a network processor, such as a switching ASIC or another type of network processor.

The back end of board mount connector 302 comprises a mating interface 308 for mating with one or more complementary connectors (e.g., non-board mount connectors). In one embodiment, mating interface 308 is configured to mate with one or more cable connectors where each mating cable connector terminates one or more cables (e.g., one or more low insertion loss cables, such as twinax cables).

Mating interface 308 comprises a pattern (e.g., an array) of contact areas with each contact area including one or more mating interface signal contacts configured to form electrical connections with corresponding contacts of a mating connector. The mating interface signal contacts of a contact area are electrically connected to board mount contacts of board mount connector 302 and are configured to form electrical connections with corresponding contacts of a mating connector contacts. Board mount connector 302 thus connects signal paths between board traces of PCB 350 and the mating connector(s).

Cable connector 304 is mounted to board mount connector 302 away from board mount side 306 and PCB 350. Cable connector 304 comprises a respective housing 312 that can be formed of an insulative material that defines a front end and a back end and supports a plurality of mating interface signal contacts. The front end of housing 312 is configured to receive conductive cables 314 (e.g., low insertion loss cables, such as twinax cables), which are terminated at cable connector 304. In one embodiment, the opposite ends of cables 314 (not shown) terminate at a cable to board connection that is, in turn, connected by traces to a network processor, such as switching ASIC or another type of network processor.

The back end of cable connector 304 comprises a mating interface 316 for mating with one or more complementary connectors. In one embodiment, mating interface 316 is configured to mate with one or more cable connectors where each mating cable connector terminates one or more cables (e.g., one or more low insertion loss cables, such as twinax cables).

Mating interface 316 comprises a pattern (e.g., an array) of contact areas (with each contact area including one or more signal contacts (mating interface signal contacts). The mating interface signal contacts of a contact area are electrically connected to a respective cable 314 and are configured to form electrical connections with corresponding contacts of a mating connector. Board mount connector 302 thus connects signal paths between cables 314 and the mating connector(s).

The overall mating interface of hybrid connector 300 has an (X×Y) connector configuration with X rows by Y columns of contact areas to support up to (X×Y)/2 lanes or (X×Y) diff pairs. The number rows and columns may vary by implementation. For example, cable connector 304 has a 12×10 connector configuration that can support up to 120 diff pairs or 60 data lanes (where each data lane comprises a diff pair). A given network device, however, may use fewer diff pairs/data lanes than the maximum number supported by the hybrid connector.

Further, the segregation of rows or columns between the board mount connector and the cable connector may vary by implementation. In one embodiment, for example, each cable connector provides (X/2) rows. In FIG. 3, for example, the top six rows are provided by cable connector 304 and the bottom six rows are provided by board mount connector 302 with the columns being split across the connectors. In other embodiments, the rows may be otherwise divided between the cable connector and board mount connector.

According to one embodiment, one or more mating connectors (e.g., press fit connectors) may be mated with hybrid connector 300. Whether one or multiple mating connectors are mated with hybrid connector 300, a given mating connector may span across board connector 302 and cable connector 304.

Hybrid connector 300 includes a pair of spaced sidewalls 320, each of which has a respective base 322 (e.g., a flange or other portion to act as a base) and upper member 324 (e.g., flange). Each base 322 includes an opening 326 such that each sidewall 320 may be aligned on a guide pin or attached to the PCB or other support structure using a screw or other fastener. Each upper member 324 includes an opening 328 such that a cover may be aligned on hybrid connector 300 (e.g., using guide pins on the cover) or attached to the sidewalls using screws or other fasteners. Upper members 324 further include alignment features, such as alignment pins 330, to aid in aligning a cover over hybrid connector 300.

One or more of the sidewalls 320 may include or be coupled to a rearwardly extending panel 332 that extends past mating interface 308 or mating interface 316. In one embodiment, panel 332 includes guide features 334 projecting from panel 332, to help align a mating connector with hybrid connector 300. A mating connector may include one or more grooves to receive guide features 334 such that the mating connector is guided along a mating axis as it is being connected to hybrid connector 300.

With reference to FIG. 3C, hybrid connector 300 includes guide features to guide board mount connector 302 and cable connector 304 into position during assembly. For example, at least one of the sidewalls 320 comprises an inward projection, the board mount connector defines a first slot into which the inward projection projects and the cable connector defines a second slot into which the inward projection projects. In the illustrated embodiment, for example, the inner surface of each sidewall 320 includes a vertically elongated guide projection 340, the sides of housing 303 includes slots 342 (only one slot 342 is visible in FIG. 3C) to receive guide projections 340 and housing 312 includes respective slots 344 (only one slot 344 is visible in FIG. 3C) to receive the guide projections 340. The guide projections 340 on the inner surfaces of sidewalls 320 and respective slots in the side surfaces of housing 303 form a prismatic joint that allows board mount connector 302 to slide into position on PCB 350 during assembly. Similarly, the guide protrusions on the inner surfaces of sidewalls 320 and respective slots in the side surfaces of housing 303 form a prismatic joint that allows cable connector 304 to slide into place on top of board mount connector 302. Alignment pins 346 are provided on housing 303 and extend into holes 348 of housing 312 when cable connector 304 is properly stacked on board mount connector 302.

According to one embodiment, sidewalls 320 are installed on a PCB. Board mount connector 302 is guided to a location on PCB using guide projections 340 and assembled to the PCB with board mount technology. Cable connector 304 is guided into place by guide projections 340 and tightly assembled to act as a single connector. In one embodiment, for example, PCB 350, sidewalls 320, and a cover surround the stacked board mount connector 302 and cable connector 304 on the top, bottom, and sides. Guide projections 340 and alignment pins 346 prevent cable connector 304 from moving back or forward relative to board mount connector 302. Hybrid connector 300 acts as a single connector such that a mating connector can mate to hybrid connector 300 across board mount connector 302 and cable connector 304 as if they are single connector. Thus, for example, a mating cable connector can be connected to hybrid connector 300 where a portion of the mating cable connector mates with board mount connector 302 and another portion mates with cable connector 304 as if hybrid connector 300 is a single connector.

When installed on a board, board mount connector 302 is connected to one or more other components, such as a switching ASIC or another type of processor, via traces embedded in the PCB. Moreover, cable connector 304 is connected to one or more components of the system via cables. For example, cables may be connected between cable connector 304 and a cable-to-board connector to connect signal paths between cable connector 304 and an ASIC or other processor.

In the embodiment of FIG. 3, board mount connector 302 and cable connector 304 are each formed as a separate connector and then assembled into a hybrid connector that acts as a single connector. The embodiment of FIG. 3 further provides the ability to disassemble the connector. Thus, for example, if cable connector 304 is to be replaced (e.g., due to damage or for any other reason), it may be non-destructively removed (i.e., without damaging board mount connector 302, requiring breaking of adhesive or other bonding agent between cable connector 304 and board mount connector 302, etc.) and replaced without having to remove and replace board mount connector 302. Similarly, if board mount connector 302 is damaged or otherwise requires replacement, it may be replaced without requiring a replacement cable connector 304.

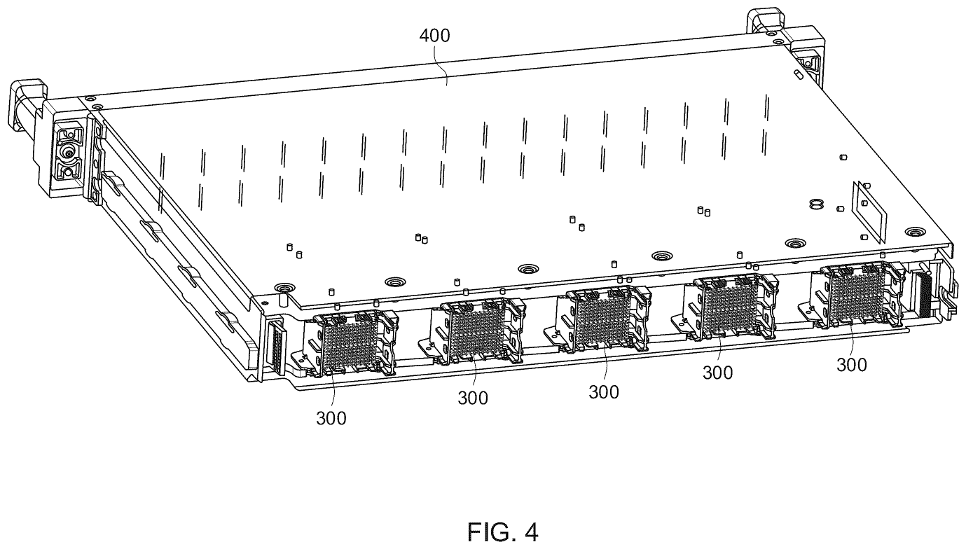

FIG. 4 is a diagrammatic representation of a back side of one embodiment of a line card 400 that has five hybrid connectors 300 for backplane connectors. The stacked arrangement of hybrid connectors 300 saves board space. For example, the internal PCB and chassis of line card 400 would be significantly longer if ten side-by-side connectors (e.g., ten 6×10 connectors side-by-side) were used instead of the five hybrid connectors 300. This could result in longer trace lengths and corresponding increases in insertion loss or would require additional cabling bulk in the line card. Moreover, the overall size of the modular network device in which the line card is incorporated would have to be larger to accommodate the larger line card.

While FIG. 4 illustrates a network device with five hybrid connectors 300, it will be appreciated that a network device can have any number of hybrid connectors, depending on implementation.

Hybrid connector 300 is illustrated as having a stacked arrangement in which board mount connector 302 is mounted to the PCB and cable connector 304 stacks on board mount connector 302 on the side of board mount connector 302 away from the PCB. In other embodiments, the hybrid connector can be otherwise arranged. FIG. 5, for example, is a diagrammatic representation of a hybrid connector 500 comprising a board mount connector 502 and a cable connector 504. In the embodiment illustrated, board mount connector 502 mounts to PCB 505 using surface mount technologies, compression contacts, press fit pins, solder tails, or other board mounting technique and is connected to other components (e.g., a switching ASIC or other processor) via board traces. Cable connector 504 connects to other components via a cabled connection. Using hybrid connector 500 with the example architecture of FIG. 2, board mount connector 502 of a hybrid connector 500 connects to the nearest ASIC via board traces and the cable connector 504 portion of hybrid connector 500 connects to the ASIC that is farther away via a cabled connection, though other schemes for connecting signal paths may be used.

Board mount connector 502 and cable connector are assembled to act as a single connector such that a mating connector can mate across the board mount connector and cable connector as if they are single connector. According to one embodiment, hybrid connector 500 provides (X×Y) connector configuration with X rows by Y columns where board mount connector provides a first number of columns and cable connector provides the remaining columns with the rows being split across the board mount connector 502 and cable connector 504.

FIG. 6 is a diagrammatic representation of one embodiment of a hybrid connector 600 that comprises a board mount connector 602 and a cable connector 604 in a stacked arrangement. Board mount connector 602 is mounted to PCB 606 such that the board mount signal contacts (e.g., pads, pins, balls, solderless compression contacts, solder tails or other board mount features) connect to traces of PCB 606. Board mount connector 602 comprises electrical connections (e.g., high speed signal pins) connecting the board mount signal contacts to mating interface signal contacts (e.g., board mount signal contact 608 is electrically connected to mating interface signal contact 610 by connection 612). At cable connector 610, the conductors of the signaling cables are electrically connected to mating interface signal contacts (e.g., a conductor of cable 620 is electrically connected to mating interface signal contacts). For a cable with multiple conductors, such as a twinax cable, each conductor may be connected to a respective mating interface signal contact in some embodiments.

FIG. 7 is a diagrammatic representation of one embodiment of a hybrid connector 700 that comprises a board mount connector 702 and a cable connector in a side-by-side arrangement (the cable connector is hidden by board mount connector 702 in FIG. 7). Board mount connector 702 is mounted to PCB 706 such that the board mount signal contacts (e.g., pads, pins, balls, solderless compression contacts, solder tails or other board mount features) connect to traces of PCB 706. Board mount connector 702 comprises electrical connections (e.g., high speed signal pins) connecting the board mount signal contacts to mating interface signal contacts (e.g., board mount signal contact 708 is electrically connected to mating interface signal contact 710 by connection 712). At the cable connector, the conductors of the signaling cables 720 are electrically connected to mating interface signal contacts.

Comparing FIG. 6 to FIG. 7, it can be noted that the longest internal signal path lengths of hybrid connector 700 (e.g., connection 712) is longer than the longest internal signal path length of hybrid connector 600 (e.g., connection 612). The stacked arrangement of hybrid connector 600 results in a lower insertion loss and a smaller connector footprint on the board compared to hybrid connector 700.

FIG. 6 and FIG. 7 are provided by way of example and not limitation. The number of rows in the board mount connector and cable connector may vary by implementation. Moreover, the internal routing of connection is simply illustrative.

In this disclosure, specific embodiments have been described with reference to the accompanying figures. In the above description, numerous details are set forth as examples. It will be understood by those skilled in the art, and having the benefit of this Detailed Description, that one or more embodiments described herein may be practiced without these specific details and that numerous variations or modifications may be possible without departing from the scope of the embodiments. Certain details known to those of ordinary skill in the art may be omitted to avoid obscuring the description.

In the above description of the figures, any component described with regard to a figure, in various embodiments, may be equivalent to one or more like-named components shown and/or described with regard to any other figure. For brevity, descriptions of these components may not be repeated with regard to each figure. Thus, each and every embodiment of the components of each figure is incorporated by reference and assumed to be optionally present within every other figure having one or more like-named components. Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A hybrid connector comprising:
a board mount connector comprising a board mount side that is board mountable to a printed circuit board (PCB), the board mount connector having a first mating interface for mating with a non-board mount connector; and
a cable connector mounted to the board mount connector away from the board mount side, the cable connector terminating a plurality of cables and having a second mating interface.

2. The hybrid connector of claim 1, further comprising:
a pair of sidewalls, wherein the board mount connector and the cable connector are disposed between the pair of sidewalls.

3. The hybrid connector of claim 2, wherein the pair of sidewalls are mountable to the PCB.

4. The hybrid connector of claim 2, wherein at least one of the sidewalls comprises an inward projection, wherein the board mount connector defines a first slot into which the inward projection projects, and wherein the cable connector defines a second slot into which the inward projection projects.

5. The hybrid connector of claim 1, wherein the board mount connector comprises an alignment pin to align the cable connector on the board mount connector and wherein the cable connector comprises an opening to receive the alignment pin.

6. The hybrid connector of claim 1, wherein the first mating interface comprises a first array of contact areas and wherein the second mating interface comprises a second array of contact areas.

7. The hybrid connector of claim 1, wherein the first mating interface and the second mating interface are each adapted to interface with a mating cable connector.

8. The hybrid connector of claim 1, wherein the cable connector is non-destructively removable from the hybrid connector.

9. A network device comprising:
a printed circuit board (PCB);
a first switching ASIC mounted to the PCB;
a second switching ASIC mounted to the PCB;
a hybrid connector, the hybrid connector comprising:
a board mount connector mounted to the PCB, the board mount connector comprising a first mating interface for mating with a non-board mount connector; and
a cable connector mounted to the board mount connector away from the PCB, the cable connector terminating a plurality of cables, the cable connector comprising a second mating interface; and
wherein the hybrid connector is connected to the first switching ASIC by board traces in the PCB and wherein the hybrid connector is connected to the second switching ASIC via the plurality of cables.

10. The network device of claim 9, wherein the first switching ASIC is closer to the hybrid connector than the second switching ASIC is to the hybrid connector.

11. The network device of claim 9, wherein the network device comprises a plurality of hybrid connectors and wherein each of the first switching ASIC and the second switching ASIC is connected to each of the hybrid connectors.

12. The network device of claim 11, wherein each of the hybrid connectors is a backplane connector.

13. The network device of claim 9, further comprising a pair of sidewalls mounted to the PCB, wherein the board mount connector and the cable connector are disposed between the sidewalls.

14. The network device of claim 13, wherein at least one of the sidewalls comprises an inward projection, wherein the board mount connector defines a first slot into which the inward projection projects, and wherein the cable connector defines a second slot into which the inward projection projects.

15. The network device of claim 13, wherein the board mount connector comprises an alignment pin to align the cable connector on the board mount connector and wherein the cable connector comprises an opening to receive the alignment pin.

16. The network device of claim 13, wherein the first mating interface comprises a first array of contact areas and wherein the second mating interface comprises a second array of contact areas.

17. The network device of claim 9, wherein the cable connector is non-destructively removable from the hybrid connector.

18. The network device of claim 9, wherein the first mating interface and the second mating interface are each adapted to interface with a mating cable connector.

19. A method for an input/output connector, the method comprising:
assembling a hybrid connector, wherein assembling the hybrid connector comprises:
mounting a board mount connector to a printed circuit board (PCB), the board mount connector comprising a mating interface for mating with a non-board mount connector;
mounting a cable connector to the board mount connector away from the PCB, the cable connector terminating a plurality of cables and comprising a second mating interface; and
connecting the hybrid connector to a first network processor via the plurality of cables.

20. The method of claim 19, further comprising:
mounting a pair of sidewalls to the PCB prior to mounting the board mount connector to the PCB; and
using the pair of sidewalls to guide the board mount connector to the PCB and the cable connector to the board mount connector.
